(19) United States
(12) Patent Application Publication
(10) Pub. No.: US 2009/0200846 A1
(43) Pub. Date: Aug. 13, 2009

(54) Infant seat rocker device

(76) Inventor: Aviezer Yehuda, Cherry Hill, NJ (US)

Correspondence Address: Aviezer Yehuda, 1758 Fireside Lane, Cherry Hill, NJ, 08003, US

(21) Appl. No.: 12/069,898

(22) Filed: Feb. 13, 2008

(51) Int. Cl. B60N 2/44

(52) U.S. Cl. 297/271.5

(57) ABSTRACT

A automobile infant seat rocker device is portable and small enough to be stored in a pocketbook or small carrying case. It is removably attachable to an infant seat, operates on portable power and can be conveniently stored or packed when not in use. The device includes: (a) a rocker device main housing; (b) a rocker drive mechanism for creation of reciprocal motion of at least one push arm, the rocker drive mechanism being located in the main housing; (c) at least one push arm connected to the rocker drive mechanism and extending outwardly from the main housing for contact with a floor area so as to reciprocally push main housing in a reciprocal motion; (d) power mechanism for powering the rocker drive mechanism; and, (e) removable connection means for removably connecting the main housing to a lower portion of an infant seat. When the rocker device is removably connected to the base or side of an infant seat and the rocker drive mechanism powered by the power mechanism is activated, reciprocal movement of the at least one push arm reciprocally moves the main housing and rocks the infant seat.

### BACKGROUND OF INVENTION

a. Field of Invention

The invention relates generally to a device for automatically rocking an infant seat when it is resting on a flat surface. The device is hand-held, portable and is attached to the infant seat for stability, yet is easily removable therefrom, i.e., the attachment mechanisms are removably attachable attachment mechanisms.

b. Description of Related Art

The following patents are representative of various rocking devices:

U.S. Pat. No. 7,234,177 B1 to Drevitson describes a rocking machine which automatically imparts a continuous, rocking motion to an occupant recumbent on a hammock. One end of the rocking machine is attached to a fixed location. The other end of the rocking machine is attached to a conventional hammock, which is attached to a second fixed location. The rocking machine has a container that houses a periodically reversing geared motor. Operation of the motor is controlled by an electrical circuit having a shaft attached to one end of the torsional spring. The other end of the torsional spring is connected to the hammock. A pressure sensitive switch becomes actuated and moves to a closed position, enabling supply of power to the geared motor that initiates a continuous rocking motion, when the hammock becomes occupied. The electrical circuit provides periodically reversing oscillations while monitoring current to the motor, and decreases the period between oscillations until it matches the natural period of oscillation of the spring-occupant weight system. Motor current is thereby maintained at a decreased value, increasing the efficiency of energy transfer from the motor to rocking motion for said hammock.

U.S. Pat. No. 7,037,205 B1 to Bowman describes an improved baby carrier device which has an integral swinging mechanism capable of providing a pendulum-like rocking action thereto. In addition to other known uses such as a containment mechanism for infants or as a receptacle for mounting within a baby carriage, or car seat, the present invention enhances the utility of a conventional baby carrier system via the incorporation of an integral baby swing, thereby abating the need for other extraneous mechanisms or other related swing drive devices. The carrier device has a pair of leg assemblies which are incorporated into the handle assembly thereof and are selectively adjustable by a user from an extended position wherein said carrier shell is suspended above a support surface in a stable manner, to a retracted position wherein the leg assemblies are confined within the housing of the handle assembly. Self-propelled actuation means are also described which drivingly couples the rotational force of a motor drive means to the reciprocal pendulum-like action of the swing assembly.

U.S. Pat. No. 6,979,057 B2 to Sedlack describes an infant car seat which includes a car seat, a car seat base, and a mechanism for connecting the seat to the base. With the car seat base secured to a vehicle seat, the car seat can be conveniently connected to the base to safely transport an infant. The connection and release mechanisms between the car seat and the base are durable and easy to operate.

U.S. Pat. No. 6,910,696 B2 to Bargery et al. describes a transporter which can be used as an infant seat or carrier, which has a body shell with a curved lower surface for use as a rocker and wheels which can be extended for use as a stroller. The wheels are carried on legs which can be retracted into opposed side cheeks by means of respective drive bells. A handle is secured to inner members to slide within tubular arms which are pivotally secured to the side cheeks. The inner members are connected by pivotal links to the respective drive belts so that extending or retracting the handle rotates the belts to extend or retract the wheels. Release mechanisms at opposite ends of the handle lock the arms in the retracted position so that the handle can be used to carry the transporter with the wheels retracted. A release handle operates spring-loaded pins to lock the arms in the carrying or pushing positions.

U.S. Pat. No. 5,860,698 to Asenstorfer et al. describes a device for generating a rocking motion in child recliners and the like which includes a lift drive with a coupling element, wherein the coupling element of the lift drive can be brought directly into engagement with the recliner in a detachable manner without intermediate elements and assembly operations.

U.S. Pat. No. 5,588,164 to Proulx describes a base unit for supporting an infant carrier seat which is comprised of a housing member which has a bottom curved surface for rocking on a generally flat support surface, an upper central portion on which an infant carrier seat is removably mountable, an endless pathway that circumscribes said central portion, a weight and a motor to move along the weight in a closed loop at a selected predetermined rate of travel. The weight in the preferred form is a toy train unit with open topped box cars that removably hold a supply of weights. A sound generator on the train provides music and/or train whistle simulation. An infant can be entertained by the train travelling around the infant, by sounds generated by the train, and the infant is rocked, all at the same time. The motion of the train travelling around the infant can be used to check responses of the infant as can also the movement of sound relative to the infant.

U.S. Pat. No. 4,985,949 to Jantz describes an improved infant carrier seat rocker which is provided for a typical molded plastic type infant carrier seat embodying a rounded bottom to facilitate a fore and aft rocking motion. This type of seat is currently in production. The rocker is comprised of a housing from which a lifting member protrudes. A power unit is mounted within the housing. This power unit provides rotational energy. A drive means consisting of an eccentric mounted to the output of the drive unit and slidably connected to the lifting member to convert rotational energy to vertically reciprocating motion is employed to impart the vertical motion to the lifting member. The lifting member in turn imparts this motion to a suitable feature of the carrier seat, typically the lower edge of the seat, and the seat then rocks as the lifting member oscillates vertically.

U.S. Pat. No. 4,911,499 to Meeker describes an improved rocker for an infant seat which comprises in combination a base having upstanding lateral side walls defining an opening therebetween; an intermediate platform positioned within the opening and having an upper region adapted to receive an infant seat thereon; a pair of generally U-shaped links each having upper portions supported by side walls, each having a lower horizontal portion adapted to receive a lower region of the platform thereon, and each having intermediate vertical portions coupling the upper and lower portions; drive means coupling the platform and the base for inducing a rocking motion to the platform; adjustment means to longitudinally vary the center of the oscillation of the rocking platform; and locking means to lock the platform with respect to the base.

U.S. Pat. No. 4,656,680 to Wilson describes a device in which a baby is oscillated to sleep by placing it in a carrier and pivoting the carrier in oscillation about a horizontal axis adjacent to the foot end of the carrier by means of a rotating cam which provides a special predetermined motion that is effective to induce the baby to sleep. The carrier is removably mounted on a carrier support which is pivoted to an underlying base for oscillation about the aforementioned axis to impart similar motion to the carrier. The cam and its drive means is mounted on the base and enclosed together with the base by the carrier support. In the preferred embodiment, wheels are mounted to the base to allow the apparatus to be moved back and forth over a ground surface.

U.S. Pat. No. 4,598,946 to Cone describes a rocking infant seat which has an adjustable at-rest position which includes a seat having an arcuate lower support surface resting on a planar base, a slot in the seat, and a bolt extending through the slot to secure the seat to the base.

U.S. Pat. No. 4,371,206 to Johnson, Jr. describes a rockable infant seat/cradle which includes a rotatably positionable handle secured to the opposed side walls of an integrally molded infant supporting shell. The shell comprises a curved underbelly, oppositely disposed side walls extending transverse to the underbelly, and apertured rocker panel walls integral with and spaced outwardly of the side walls. A mechanism, secured to opposed, distal ends of the handle, extends through the apertures in each rocker panel and is adapted to normally lock the handle in any one of the plurality of positions. The handle locking mechanism includes a gear having a plurality of axially extending teeth, a gear retaining ring having a plurality of apertures through which the gear teeth normally extend, and a coil spring which normally biases the gear teeth into a gear ring aperture-engaging condition. The mechanism is responsive to selective axial pressure to space the gear teeth axially of the gear ring apertures so that the handle may be rotated to any one of the plurality of positions.

U.S. Pat. No. 3,851,343 to Kinslow, Jr. describes a rocker which is provided for an infant seat of the type embodying an elongated inclined floor on which the infant is reclined, and embodying side walls and an end wall at the lower end of the floor with a framework beneath the floor holding the floor inclined upwardly away from the end wall. The rocker has an elongated main platform. A motor is mounted on the platform and has a shaft extending transversely over the platform. A hollow cover having side walls and end walls and a top encloses the motor and overlies the platform. Pivot means on the platform within the cover mounts the cover for rocking movement over the platform. Lifting arm means beneath the cover near the other end thereof is carried by bell crank means fixed on the shaft. The cover has an exterior seat support on its end most remote from the cover pivot means which support is operable to engage and lift the framework and thereby rock the seat upward as the cover is raised by the lifting arm means.

U.S. Pat. No. 3,653,080 to Asenstorfer et al. describes a seat adapted for use by an infant which is automatically rocked back and forth by a suitable linkage mechanism connected by a reducing gear means to a motor.

U.S. Patent No. Des. 411,763 to Asenstorfer et al. describes a rocker drive for child recliners.

Notwithstanding the prior art, the present invention is neither taught nor rendered obvious thereby.

### SUMMARY OF INVENTION

The present invention is an automobile infant seat rocker device that is generally portable and small enough to be stored in a pocketbook or small carrying case. Unlike other infant seat rockers, the present invention device is removably attachable to the infant seat, operates on portable power and can be conveniently stored or packed when not in use. The present invention device includes: (a) a rocker device main housing; (b) a rocker drive mechanism for creation of reciprocal motion of at least one push arm, the rocker drive mechanism being located in the main housing; (c) at least one push arm connected to the rocker drive mechanism and extending outwardly from the main housing for contact with a floor area so as to reciprocally push main housing in a reciprocal motion; (d) power means for powering the rocker drive mechanism; and, (e) removable connection means for removably connecting the main housing to a lower portion of an infant seat; wherein, when the rocker device is removably connected to the base or side of an infant seat and the rocker drive mechanism is powered by the power means, reciprocal movement of the at least one push arm reciprocally moves the main housing and rocks the infant seat.

In some preferred embodiments of the present invention the infant seat rocker device, the removable attachment means is selected from the group consisting of a quick release latch, a quick release lock, a hook and loop set of complementary strips, a snap-in mechanism and a clamp.

In some preferred embodiments of the present invention the infant seat rocker device, the power means is a portable power means selected from the group consisting of a solar power pack, a battery, a fuel cell and combinations thereof.

For some preferred embodiments of the present invention the infant seat rocker device, the rocker drive mechanism includes a motor with an eccentric connection to the at least one push arm.

For some preferred embodiments of the present invention the infant seat rocker device, the device further includes a holding case, the holding case being adapted to receive and hold the main housing and having means for attachment to a wall of an infant seat.

For some preferred embodiments of the present invention the infant seat rocker device, the device removable attachment means is selected from the group consisting of a bolt and wingnut and a magnetic bolt.

For some preferred embodiments of the present invention the infant seat rocker device, the rocker drive mechanism includes an electronically operated solenoid for alternatively extending and retracting the at least one push arm.

For some preferred embodiments of the present invention the infant seat rocker device, the main housing is a plastic main housing.

For some preferred embodiments of the present invention the infant seat rocker device, the at least one push arm is at least one cam push arm.

For some preferred embodiments of the present invention the infant seat rocker device, the at least one push arm is at least one push rod.

In a different preferred embodiment of the present invention, the device is a hand-held, portable automobile infant seat rocker device that includes: (a) a rocker device main housing having a maximum dimension no greater than six inches and, in some cases, no greater than four inches; (b) a rocker drive mechanism for creation of reciprocal motion of at least one push arm, the rocker drive mechanism being located in the main housing; (c) at least one push arm connected to the rocker drive mechanism and extending outwardly from the main housing for contact with a floor area so as to reciprocally push main housing in a reciprocal motion; (d) power means for powering the rocker drive mechanism; and, (e) removable connection means for removably connecting the main housing to a lower portion of an infant seat; wherein, when the rocker device is removably connected to the base or side of an infant seat and the rocker drive mechanism is powered by the power means, reciprocal movement of the at least one push arm reciprocally moves the main housing and rocks the infant seat. In this defined version having a maximum dimension no greater than six inches, all of the options and alternatives and limitations of paragraphs [00019] through [00027] apply here as well.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a side cut view of one preferred embodiment of a hand-held, portable infant rocker device with a cam push arm;

FIG. 2 shows the same present invention device shown in FIG. 1, but with the cam push arm in an extended position to cause an infant seat to which it might be attached to rock;

FIG. 3 is a side cut view of another preferred embodiment of a hand-held, portable infant rocker device with a cam push arm established by an eccentric round cam;

FIG. 4 shows the same present invention device shown in FIG. 3, but with the cam push arm in an extended position to cause an infant seat to which it might be attached to rock;

FIG. 5 is a side cut view of a third preferred embodiment of a hand-held, portable infant rocker device with two push rods as the push arms;

FIG. 6 is a side cut view of another preferred embodiment of a hand-held, portable infant rocker device with solenoid activation mechanism and with a piston and base acting as the push rod;

FIG. 7 is an enlarged side view of an infant seat with a present invention device attached to its side and showing a separately attached carrying case;

FIG. 8 is an enlarged side view of an infant seat with a present invention device attached to its front and showing a separately attached carrying case; and

FIG. 9 is an enlarged side view of an infant seat with a present invention device attached to its back and showing a separately attached carrying case.

### DESCRIPTION OF THE EMBODIMENTS

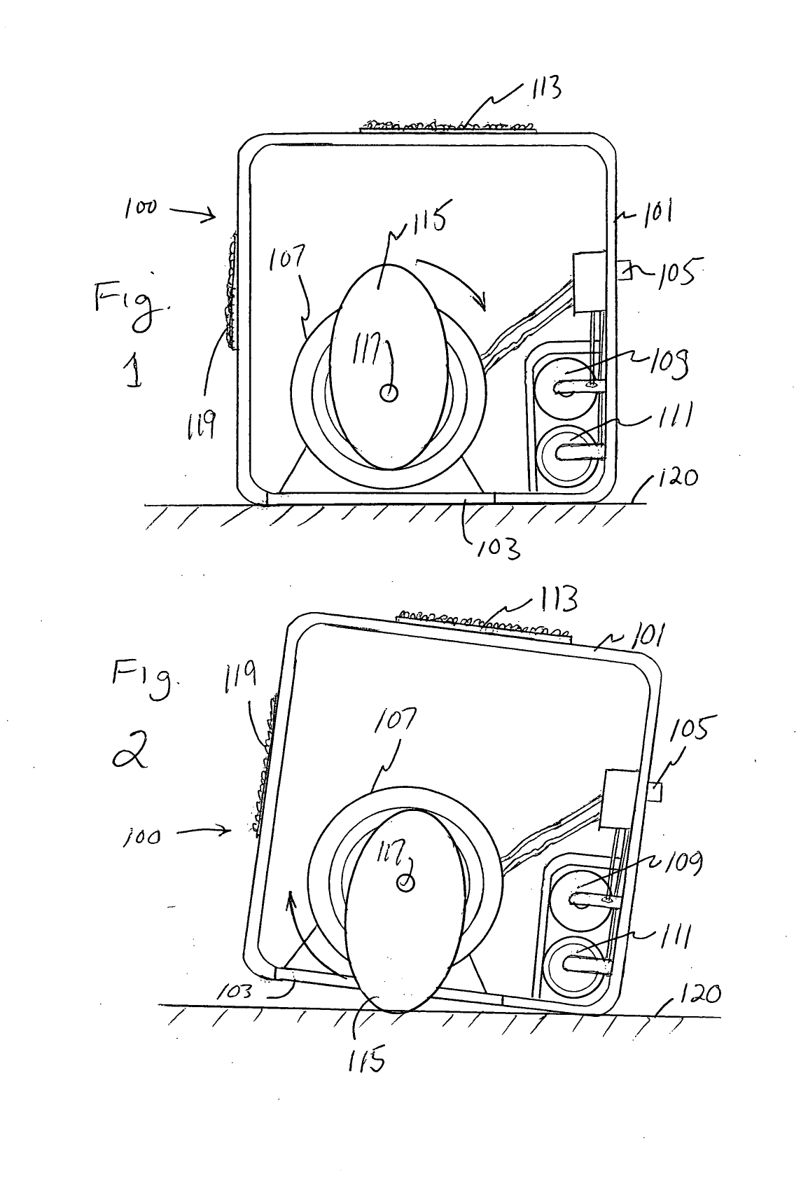

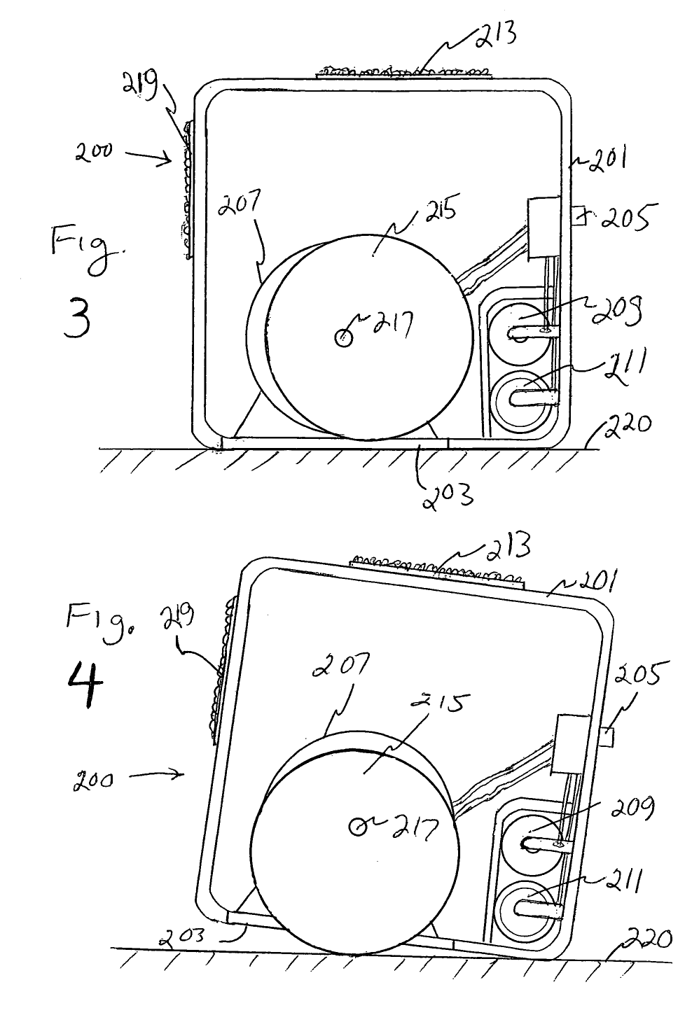

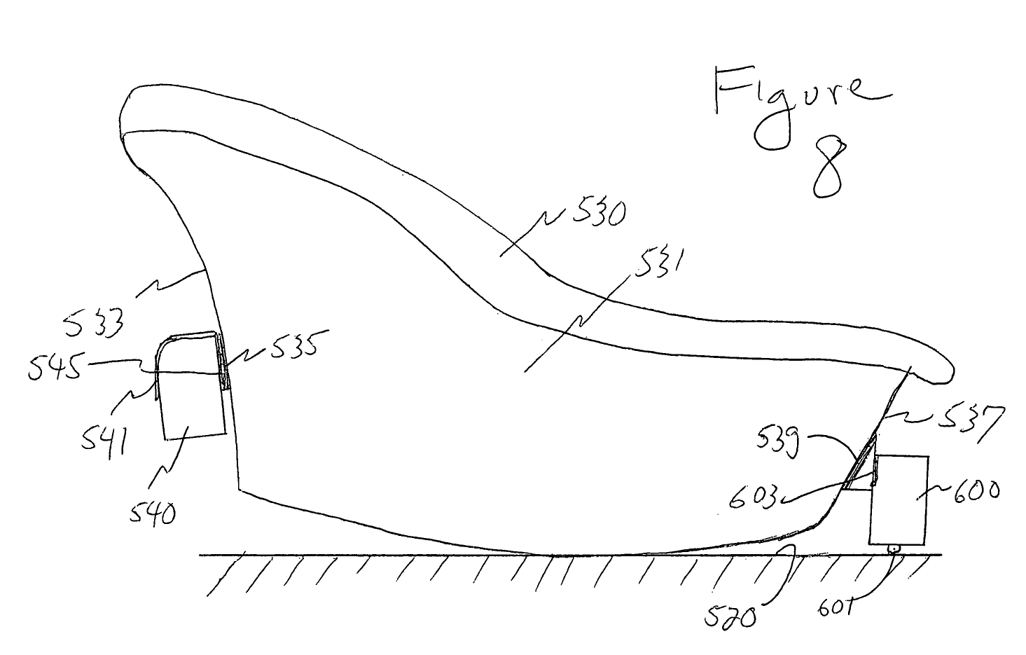

FIG. 1 is a side cut view of one preferred embodiment of a hand-held, portable infant rocker device 100. It includes a plastic main housing 101, with an opening 103 at its bottom to allow the push arm to extend and retract or otherwise go create reciprocal movement of main housing 101 (and any infant seat to which it may be attached). It has an on/off switch 105 connected to a power source, here, batteries 109 and 111, and connected to DC motor 107. When on, motor 107 drives shaft 117 and this being connected to the push arm, in this case, oval cam 115, drives the cam 115. As the cam slowly runs its full circle, it pushes down then eases up against floor 120, causing reciprocal motion of device 100 relative to the floor 120, creating the rocking cycle. FIG. 1 shows cam 115 in its uppermost (retracted) position and FIG. 2 shows it in its lowermost (extended) position. When attached to an infant seat by its attachment means, e.g., by hook and loop (Velcro®) attachment 113 to the bottom of an infant seat, or by hook and loop attachment 119 to the front of an infant seat or otherwise attached, such as is shown in the FIGS. 7, 8 and 9 below, it will rock the infant seat when switch 105 is turned on.

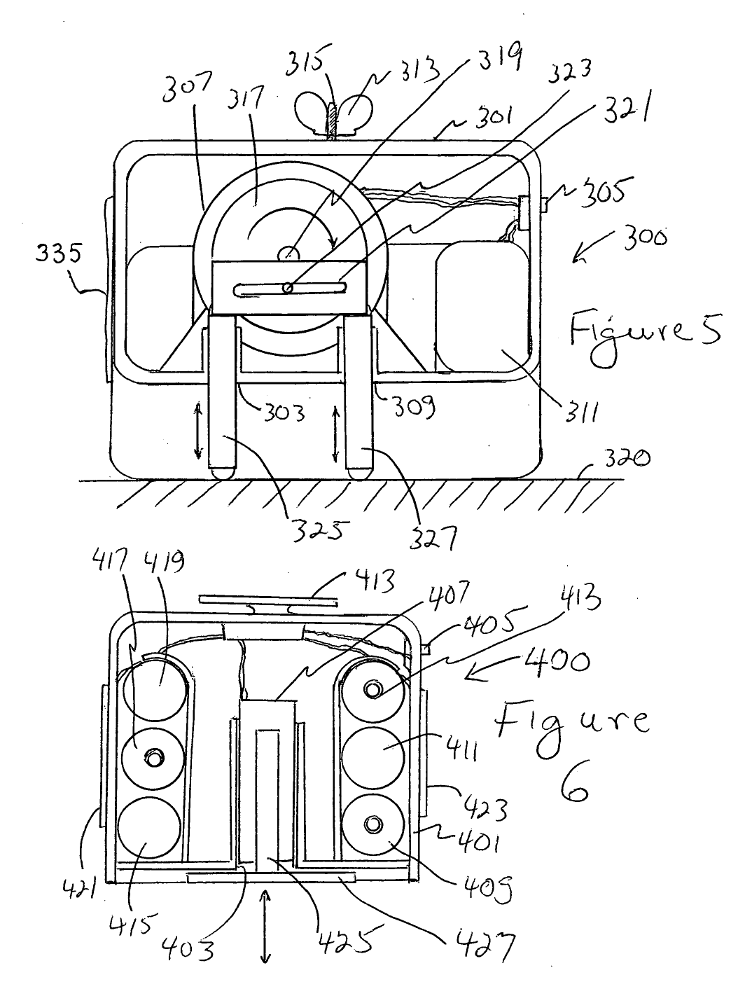

FIG. 3 is a side cut view of a different preferred embodiment of a hand-held, portable infant rocker device 200. It includes a plastic or metal main housing 201, with an opening 203 at its bottom to allow the push arm to extend and retract or otherwise go create reciprocal movement of main housing 201 (and any infant seat to which it may be attached). It has an on/off switch 205 connected to batteries 209 and 211, and to DC motor 207. When on, motor 207 drives shaft 217 which is connected to and drives eccentrically connected round cam 215. As the cam slowly runs its full circle, it pushes down then eases up against floor 220, causing reciprocal motion of device 200 relative to the floor 120, creating the rocking cycle. FIG. 3 shows cam 215 in its quarter circle (partially retracted) position and FIG. 4 shows it in its lowermost (extended) position. When attached to an infant seat by its attachment means, e.g., by hook and loop (Velcro®) attachment 213 to the bottom of an infant seat, or by hook and loop attachment 219 to the front of an infant seat or otherwise attached, such as is shown in the FIGS. 7, 8 and 9 below, it will rock the infant seat when turned on.

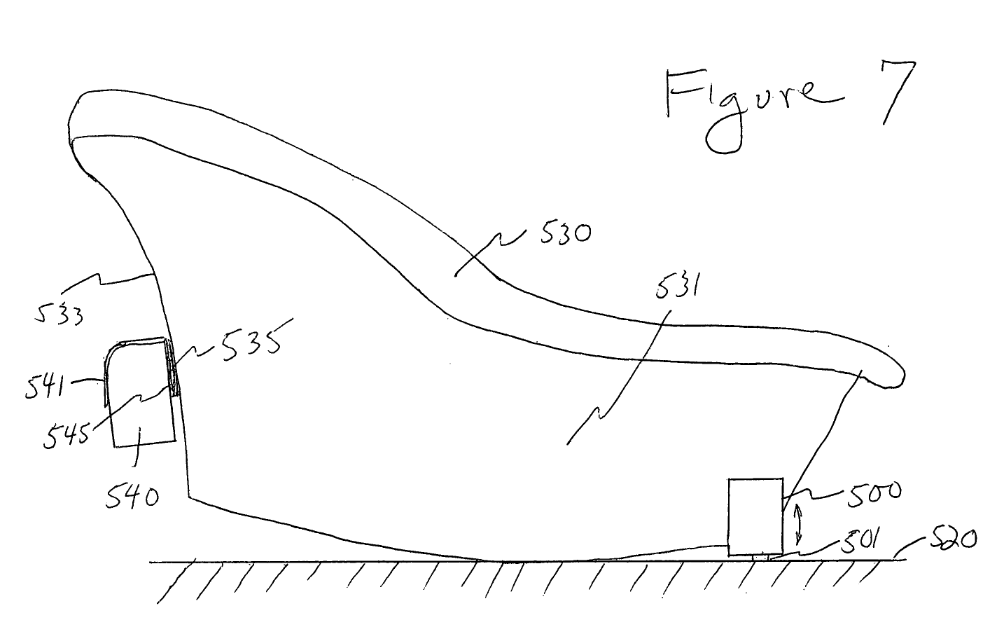

FIG. 5 is a side cut view of a third preferred embodiment of a hand-held, portable infant rocker device 300 utilizing two push rods as the push arms. It includes a plastic main housing 301, with openings 303 and 309 for push rods 325 and 327, at its bottom, as shown. to The openings 303 and 309 and their upwardly extending collars, allow the push rods 325 and 327 to extend and retract or otherwise go create reciprocal movement of main housing 301 (and any infant seat to which it may be attached). It has an on/off switch 305 connected to a power source, here, fuel cell 311, and it is connected to control the power to DC motor 307. When on, motor 307 drives shaft 319 which drives round plate 317 with an eccentrically positioned peg 323. Peg 323 is movably nested is receiver 321. As the plate 317 slowly runs its full circle, it pushes down on receiver 321 then lifts it up, causing reciprocal motion of rods 325 and 327 and device 300 relative to the floor 320, creating the rocking cycle. When attached to an infant seat by its attachment means, e.g., by hook and loop (Velcro®) attachment 313 to the bottom of an infant seat, or by magnetic strip 335 to the front or back of an infant seat or otherwise attached, such as is shown in the FIGS. 7, 8 and 9 below, it will rock the infant seat when it is turned on.

FIG. 6 is a side cut view of another preferred embodiment of a hand-held, portable infant rocker device 400, with a solenoid activation mechanism and with a piston and base acting as the push rod. It includes a plastic main housing 301, with openings 303 and 309 for push rods 325 and 327, at its bottom, as shown. to The openings 303 and 309 and their upwardly extending collars, allow the push rods 325 and 327 to extend and retract or otherwise go create reciprocal movement of main housing 301 (and any infant seat to which it may be attached). It has an on/off switch 305 connected to a power source, here, fuel cell 311, and it is connected to control the power to DC motor 307. When on, motor 307 drives shaft 319 which drives round plate 317 with an eccentrically positioned peg 323. Peg 323 is movably nested is receiver 321. As the plate 317 slowly runs its full circle, it pushes down on receiver 321 then lifts it up, causing reciprocal motion of rods 325 and 327 and device 300 relative to the floor 320, creating the rocking cycle. When attached to an infant seat by its attachment means, e.g., by hook and loop (Velcro®) attachment 313 to the bottom of an infant seat, or by magnetic strip 335 to the front or back of an infant seat or otherwise attached, such as is shown in the FIGS. 7, 8 and 9 below, it will rock the infant seat when it is turned on.

FIG. 7 is an enlarged side view of an infant seat 530 with a present invention device 500 attached to infant seat side 531 and showing a separately attached carrying case 540, attached with hook and loop (Velcro® for example) male connector 535 and female connector 545. Infant seat 530 may be any commercially available infant seat, including stand-alones and those with nesting bases. While present invention rocker device 500 is shown attached near the front of infant seat 530 on its side 531, it could be attached on any portion of infant seat 530 that would permit rocking. When infant seat rocker device 500 is activated, its push rod 501 will reciprocate against floor 520, thereby causing the rocking of infant seat 530. In many instances, the infant seats are strapped into an automobile seat such that if the present invention infant seat rocker device were left in place it would interfere with proper connection to the automobile seat, therefore a critical feature of the present invention rocker device 500 is its removability from the infant seat. It is easily attached and easily removed by any quick-attach, quick-release fastener, including all of those described above. With respect to FIG. 7, device 500 may easily be removed and carried in a shirt pocket, a purse, a pocketbook, a diaper bag, or any other tote bag. Alternatively, device 500 may be stored in carrying case device 540. Carrying case flap 541 easily lifts up, device 500 is inserted, and flap 541 sealed.

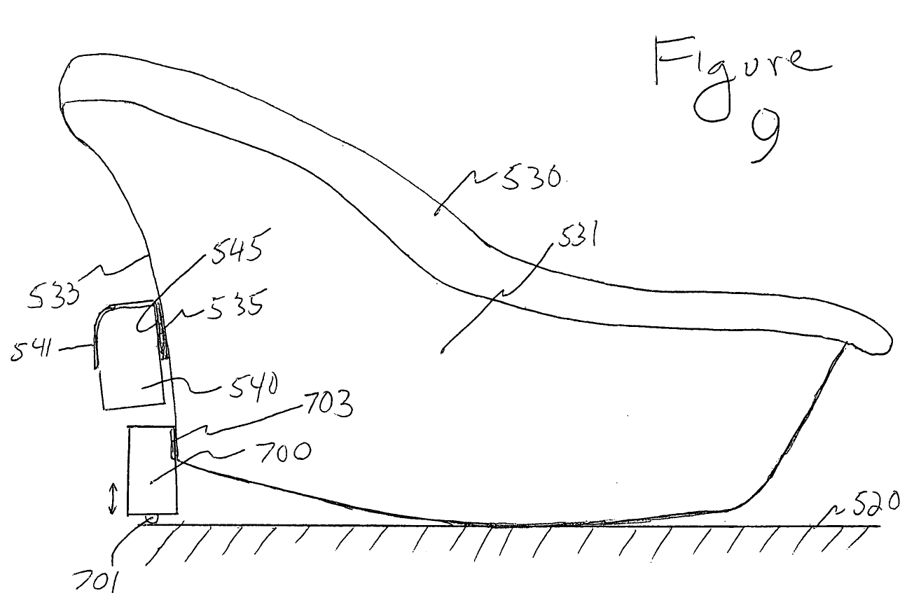

FIG. 8 is an enlarged side view of an infant seat 530 with a present invention device 600 attached to its front and showing a separately attached carrying case 540. The infant seat 530 and the carrying case 540 as well as floor 520 are the same as shown in FIG. 7 and detail reference numerals described above are repeated for this Figure and need not be redescribed. In this Figure, present invention device 600 and its push rod 601 are attached to the front 537 of infant seat 530. Attachment means 603 is a clip that may either snap fit or slide into receiver 539.

FIG. 9 is an enlarged side view of an infant seat 530 with a present invention device 700 attached to its back and showing a separately attached carrying case 540. The infant seat 530 and the carrying case 540 as well as floor 520 are the same as shown in FIG. 7 and detail reference numerals described above are repeated for this Figure and need not be redescribed. In this embodiment, present invention infant seat rocker device 700 with push rod 701 and attachment means 703 is connected to back 533 of infant seat 530.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, in addition to the embodiments described above, the present invention device may include one or more sound features. These sound features could be digital music players similar to MP-3s, radio receivers, including satellite radio, or other music playing or music recording/playback components. They could be connected to the same power source in the rocker device that powers the drive mechanism or they may have their own power supply. The sound features may preferably be positioned within the main housing of the rocker device and may be connected so as to automatically be turned on and off when the drive mechanism is turned on and off. Alternatively, they may have independent on/off controls. They would also have volume controls, and, in the case of radios, have station selection controls. Additionally, in some more sophisticated versions, backtrack, rewind and/or selection capabilities could be included. These sound features could include pre-recorded single songs such as a lullaby, could have a selection of selected or customized music, or could even include the recording of a parent singing or talking to the child.

What is claimed is:

1. An automobile infant seat rocker device, which comprises:
(a) a rocker device main housing;
(b) a rocker drive mechanism for creation of reciprocal motion of at least one push arm, said rocker drive mechanism being located in said main housing;
(c) at least one push arm connected to said rocker drive mechanism and extending outwardly from said main housing for contact with a floor area so as to reciprocally push main housing in a reciprocal motion;
(d) power means for powering said rocker drive mechanism; and,
(e) removable connection means for removably connecting said main housing to a lower portion of an infant seat; wherein, when said rocker device is removably connected to the base or side of an infant seat and said rocker drive mechanism is powered by said power means, reciprocal movement of said at least one push arm reciprocally moves said main housing and rocks said infant seat.

2. The automobile infant seat rocker device of claim 1 wherein said removable attachment means is selected from the group consisting of a quick release latch, a quick release lock, a hook and loop set of complementary strips, a snap-in mechanism and a clamp.

3. The automobile infant seat rocker device of claim 1 wherein said power means is a portable power means selected from the group consisting of a solar power pack, a battery, a fuel cell and combinations thereof.

4. The automobile infant seat rocker device of claim 1 wherein said rocker drive mechanism includes a motor with an eccentric connection to said at least one push arm.

5. The automobile infant seat rocker device of claim 1 wherein said device further includes a holding case, said holding case adapted to receive and hold said main housing and having means for attachment to a wall of an infant seat.

6. The automobile infant seat rocker device of claim 1 wherein said removable attachment means is selected from the group consisting of a bolt and wingnut and a magnetic bolt.

7. The automobile infant seat rocker device of claim 1 wherein said rocker drive mechanism includes an electronically operated solenoid for alternatively extending and retracting said at least one push arm.

8. The automobile infant seat rocker device of claim 1 wherein said main housing is a plastic main housing.

9. The automobile infant seat rocker device of claim 1 wherein said at least one push arm is at least one cam push arm.

10. The automobile infant seat rocker device of claim 1 wherein said at least one push arm is at least one push rod.

11. A hand-held, portable automobile infant seat rocker device, which comprises:
(a) a rocker device main housing having a maximum dimension no greater than six inches;
(b) a rocker drive mechanism for creation of reciprocal motion of at least one push arm, said rocker drive mechanism being located in said main housing;
(c) at least one push arm connected to said rocker drive mechanism and extending outwardly from said main housing for contact with a floor area so as to reciprocally push main housing in a reciprocal motion;
(d) power means for powering said rocker drive mechanism; and,
(e) removable connection means for removably connecting said main housing to a lower portion of an infant seat; wherein, when said rocker device is removably connected to the base or side of an infant seat and said rocker drive mechanism is powered by said power means, reciprocal movement of said at least one push arm reciprocally moves said main housing and rocks said infant seat.

12. The hand-held, portable automobile infant seat rocker device of claim 11 wherein said removable attachment means is selected from the group consisting of a quick release latch, a quick release lock, a hook and loop set of complementary strips, a snap-in mechanism and a clamp.

13. The hand-held, portable automobile infant seat rocker device of claim 11 wherein said power means is a portable power means selected from the group consisting of a solar power pack, a battery, a fuel cell and combinations thereof.

14. The hand-held, portable automobile infant seat rocker device of claim 11 wherein said rocker drive mechanism includes a motor with an eccentric connection to said at least one push arm.

15. The hand-held, portable automobile infant seat rocker device of claim 11 wherein said device further includes a holding case, said holding case adapted to receive and hold said main housing and having means for attachment to a wall of an infant seat.

16. The hand-held, portable automobile infant seat rocker device of claim 11 wherein said removable attachment means is selected from the group consisting of a bolt and wingnut and a magnetic bolt.

17. The hand-held, portable automobile infant seat rocker device of claim 11 wherein said rocker drive mechanism includes an electronically operated solenoid for alternatively extending and retracting said at least one push arm.

18. The hand-held, portable automobile infant seat rocker device of claim 11 wherein said main housing is a plastic main housing.

19. The hand-held, portable automobile infant seat rocker device of claim 11 wherein said at least one push arm is at least one cam push arm.

20. The hand-held, portable automobile infant seat rocker device of claim 11 wherein said at least one push arm is at least one push rod.
